(19) United States
(12) Patent Application Publication
(10) Pub. No.: US 2017/0307144 A1
(43) Pub. Date: Oct. 26, 2017

(54) COLLAPSIBLE LUMINAIRE

(71) Applicant: Lighting Science Group Corporation, Cocoa Beach, FL (US)

(72) Inventors: Mark Penley Boomgaarden, Cary, NC (US); William Meeler, Melbourne, FL (US); Albert Tomasko, Palm Bay, FL (US)

(73) Assignee: Lighting Science Group Corporation, Cocoa Beach, FL (US)

(21) Appl. No.: 15/497,755

(22) Filed: Apr. 26, 2017

Related U.S. Application Data
(60) Provisional application No. 62/327,859, filed on Apr. 26, 2016.

(51) Int. Cl. F21K 9/237; F21V 29/70; F21K 9/238; F21V 23/02; F21V 21/30; F21Y 2115/10

(52) U.S. Cl. CPC F21K 9/237; F21V 23/023; F21V 21/30; F21V 29/70; F21K 9/238; F21Y 2115/10

(57) ABSTRACT

A collapsible luminaire may include a light source carrying assembly, a housing lower section, at least one neck, and at least one hinge.

### RELATED APPLICATIONS

This application claims the benefit under 35 U.S.C. §119(e) of U.S. Provisional Patent Application Ser. No. 62/327,859 (attorney docket number 221.00253) titled Collapsible Luminaire, filed on Apr. 26, 2016, the content of which is incorporated herein by reference in its entirety.

### FIELD OF THE INVENTION

The present invention relates to the field of LED luminaires and, more specifically, to the field of collapsible LED luminaires that are at least partially collapsible.

### BACKGROUND

Packaging of traditional lamps has involved orienting the bulbs in a manner that places them vertically parallel to each other. In this configuration, however, the bases are at one end of the packaging and the optics are at the other. This requires a larger box and more shelf space in a retail outlet. Traditional lighting structure has involved a base and housing with a much narrower diameter and surface space than the optical chamber. In fact, a traditional optic is quite bulbous and the diameter and surface area may be more than five times larger than its base. Therefore, packaging traditional lighting in a vertically parallel fashion minimizes space efficiency since the wide, bulbous portion of the lighting devices are laid next to each other. To overcome this disadvantage, manufacturers have packaged the bulbs in an alternating inverse orientation so that the bases and optics of adjacent lighting devices are positioned at opposite ends of the packaging. This enables the space adjacent the smaller base of one bulb to be accommodated by the much larger diameter of the optical chamber of another bulb within the same packaging. Orienting the bulbs in an inverse manner may provide a small space advantage over the traditionally packaged bulb. The structure of the lighting devices themselves, however, do not allow for more efficient packaging.

FIG. 4A demonstrates a traditional side-by-side packaging model. FIG. 4B demonstrates the industry's attempt to overcome the inefficiency presented by the traditional packaging model. The structure of the present invention provides a markedly improved space efficiency over both packaging methods by allowing the light source carrying assembly to be foldable.

### SUMMARY OF THE INVENTION

With the above in mind, embodiments of the present invention are related to a collapsible luminaire comprising a light source carrying assembly, a housing lower section, at least one neck, and at least one hinge. The hinge may be configured as a pivot point for the light source carrying assembly. Additionally, in some embodiments the housing lower section may include a power supply. Furthermore, the at least one neck may be an arched member extending from the housing lower section to the light source carrying assembly.

In some embodiments the light source carrying assembly may be disk shaped and may include two opposing planar surfaces that include a heat spreader. The heat spreader may include a plurality of thermal apertures and in some embodiments the heat spreader may have a thickness within a range from 0.125 inches to 2 inches.

The collapsible luminaire may have a light source carrying assembly configured to be moveable between collapsed and un-collapsed position when the light source carrying assembly has rotated about the at least one hinge. In this embodiment the light source carrying assembly may be collapsed when the light source carrying assembly abuts the at least one neck.

In other embodiments the collapsible luminaire may include a light source carrying assembly with a heat spreader, a light source, an optic and an annular rim. In this embodiment the collapsible luminaire may also include an arched neck, a hinge, and a housing lower section with a power supply. The hinge may be connected to the arched neck and the light source carrying assembly and it may be structured as a pivot point for the light source carrying assembly. The light source carrying assembly may be disk shaped. Furthermore, in some embodiments the heat spreader may include a plurality of arcuate rows of thermal apertures extending from the optic to the annular rim.

In some embodiments the light source carrying assembly may include a circuit way cover extending from the annular rim to the optic. Additionally, the lower housing, the arched neck, and the circuit way cover may be configured as electrical housings for driving circuitry extending from the power supply to the light source. Certain embodiments may include a base attached to the lower housing. The base may be one of an Edison base, a bi-pin, and a wedge base.

In some embodiments the collapsible luminaire may include a base, a first buttressed housing and a second buttressed housing, at least one hinge, and a bisected light source assembly. In this embodiment each half of the bisected light source assembly may be operable to rotate along a medial axis defined by the at least one hinge. Furthermore, some embodiments may have the bisected light source assembly include a first section with a first semicircular heat spreader, a first optic portion, and a first bisected annular rim portion. The bisected light source assembly may also include a second section comprising a second semicircular heat spreader, a second optic portion, and a second bisected annular rim portion. The bisected light source assembly may be foldable.

In some embodiments the first semicircular heat spreader and second semicircular heat spreader may include a plurality of thermally conductive fins radially located around the first and second optic portions. Additionally, the first optic portion and the second optic portion may both be one of semi-ellipsoid, semi-ovoid, and semi-hemisphere in shape. Furthermore, at least one of the first and second buttressed housings may include a hollow interior capable of carrying a power supply and electrical circuitry operable to drive LEDs located on the light source assembly. In some embodiments the at least one hinge may include a plurality of cylindrical hinges, each cylindrical hinge with a medial aperture formed as a hollow interior channel operable to facilitate connection of electrical circuitry from at least one of the first buttressed housing and the second buttressed housing to a light source.

### BRIEF DESCRIPTION OF THE DRAWINGS

FIG. 1 is a perspective view of a collapsible luminaire according to an embodiment of the invention.

FIG. 2 is another perspective view of the collapsible luminaire of FIG. 1

FIG. 3 is a cut-away, cross-sectional side view of a light source carrying assembly, pivot point, and housing of the collapsible luminaire of FIG. 1 taken through line 3-3 in FIG. 1.

FIG. 4a is a side elevation view of a pair of traditional luminaires packaged in in a first orientation within a box according to the prior art.

FIG. 4b is a side elevation view of a pair of traditional luminaires packaged in a second orientation within a box according to the prior art.

FIG. 4c is a side elevation view of a pair of collapsible luminaires of FIG. 1 in a collapsed position and packaged within a box.

FIG. 5 is a perspective view of a collapsible luminaire in an uncollapsed position according to another embodiment of the invention.

FIG. 6 is a perspective view of the collapsible luminaire illustrated in FIG. 5 in a collapsed position.

FIG. 7 is a perspective view of another embodiment of a collapsible luminaire according to the present invention and in an uncollapsed position.

FIG. 8 is a perspective view of a plurality of collapsible luminaires according to an embodiment of the present invention in a collapsed position of and packaged within a box.

FIG. 9 is a perspective view of a collapsible luminaire according to an embodiment of the present invention in an uncollapsed position and installed in a can fixture and used in conjunction with a reflector assembly.

FIG. 10 is a perspective view of multiple reflector assemblies packaged with multiple collapsible luminaires according to an embodiment of the present invention and positioned inside a box.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a collapsible luminaire 100.

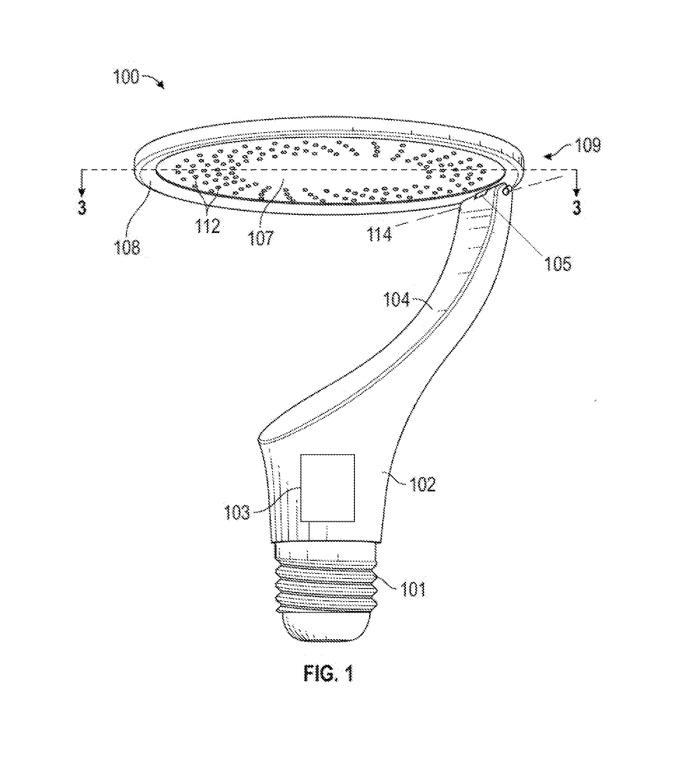

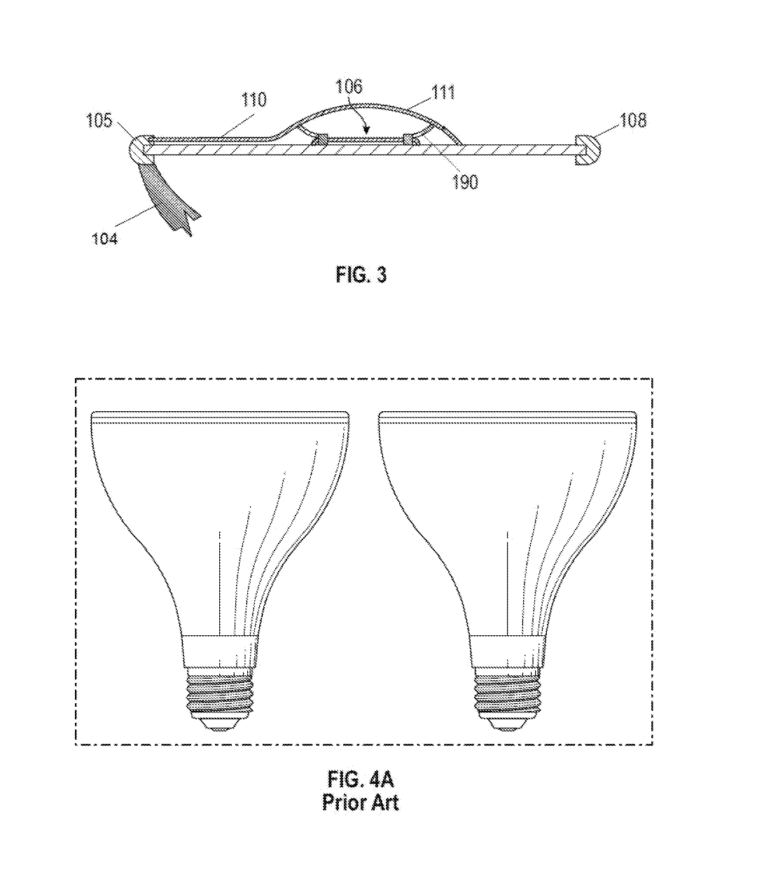

Referring initially to FIGS. 1-3, a collapsible luminaire 100 according to an embodiment of the present invention is presented. The collapsible luminaire 100 may include a base 101, a housing lower section 102, a power supply 103, a neck 104, a hinge 105, and a light source carrying assembly 109. The light source carrying assembly 109 may comprise an annular rim 108, a heat spreader 107, a circuit way cover 110, an optic 111, and a light source 106. As perhaps best illustrated in FIG. 1, the neck 104 is depicted as being an arched neck, but the skilled artisan will appreciate, after having had the benefit of reading this disclosure, that the neck may have any shape while still accomplishing the goals, features and objectives according to the present invention. The neck 104 may, for example, be considered a housing to house various components of the luminaire, as will be discussed in greater detail below.

The housing lower section 102 may be connected to the base 101 at a first end and extend distally therefrom. While the base 101 is depicted as an Edison base, it is contemplated and included within the scope of the invention that any base as is known in the art may be utilized, including, but not limited to, bi-pin, wedge, and the like. Located within the housing lower section 102 may be the power supply 103. Located at a second end of the housing lower section 102 may be the arched neck housing 104. The arched neck housing 104 may extend distally from the housing lower section 102 in an arcuate configuration and connect to the hinge 105. The hinge 105 may rotatably secure the arched neck housing 104 to the light source carrying assembly 109.

The light source 106 may include an LED chip (not shown) and an inner reflector 190. In some embodiments, the light source may include a plurality of LEDs and/or a plurality of LED dies instead of a single LED chip.

The light source carrying assembly 109 may be disk shaped and comprise a heat spreader 107 with two opposing planar surfaces. However, it is contemplated and within the scope of the invention that the light source carrying assembly 109 may be any flat shape with two planar surfaces including square, rectangular, triangular, or any polygonal or monogonal shape, including circles, ovals, and ellipses, capable of supporting a light source, heat spreader, and optic.

A first side of the heat spreader 107, defined as the lamp's emitting surface, may comprise the circuit way cover 110, the optic 111, and light source 106. The circuit way cover 110 may be an elongate channel extending from the annular rim 108 to the optic 111, which in the present embodiment is medially located, and may serve as covered electrical housing for the light source carrying assembly 109. The optic 111 may be hemispheric, ellipsoid, or ovoid in shape and may be located medially with respect to the light source carrying assembly 109. However, it is contemplated and within the scope of the invention that the optic may be of any shape capable of covering the light source and either reflecting or refracting light or permitting the traversal thereof, and may be positioned anywhere within the emitting surface.

The heat spreader 107 may be made of any thermally conductive material capable of conducting heat away from the light source 106. By way of non-limiting example, the material may be metal, copper, or polycarbonate. The heat spreader 107 may circumscribe the light source or may serve as a platform on which the light source 106 may fixedly be attached. The heat spreader 107 may be any thickness, which by way of non-limiting example may be between 0.125 and 2.0 inches. The heat spreader 107 may contain a plurality of rows of thermal apertures 112 radially located around the optic 111. In some embodiments, the plurality of rows of thermal apertures 112 may be arcuate and may extend from the optic 111 to the annular rim 108. The thermal apertures 112 may be burrowed passageways or holes on the emitting surface of the heat spreader 107 that may extend through to the opposing planar surface thereof. The thermal apertures 112 may permit fluidic flow between the environment and the heat spreader 107 thereby enhancing the thermal dissipation capacity and the overall cooling capability of the heat spreader 107.

In some embodiments the heat spreader 107 may be an assembly of two flat disk shaped members. In this embodiment the two flat disk shaped members may be fitted together as a monolithic unit and carried by the annular rim 108. Further, an upper planar surface of a first flat disk shaped member may surround the optic 111. Additionally, the second flat disk shaped member may form a platform on which the light source 106, the first flat disk, or both may fixedly be attached. An opposing side of the second flat disk shaped member may form a second side of the heat spreader.

The hinge 105 may be fixedly attached to the neck 104 at one end and the light source carrying assembly 109 at the other. In some embodiments the hinge 105 may be attached to the light source carrying assembly 109 at the annular rim 108. In other embodiments the hinge 105 may be attached to the light source carrying assembly 109 at the heat spreader 107. However, it is contemplated to be within the scope of this invention that the hinge 105 may be attached to the light source carrying assembly 109 at any portion capable of rotating the light source carrying assembly 109.

The hinge 105 may be any jointed device or flexible piece on which the light source carrying assembly 109 turns, swings or moves. As shown in FIGS. 1-3, the hinge 105 may be a pivot point whereby the light source carrying assembly 109 rotates on an axis 114 in relation to the housing lower section 102. In one embodiment the light source carrying assembly 109 may rotate from a position where it abuts the neck 104, defined as the collapsed position, to a position perpendicular to a longitudinal axis of the base 101, defined as the open position. The hinge 105 may comprise an “L” bracket wherein a first segment of the “L” bracket is parallel to a longitudinal axis of the luminaire 100 and a second segment of the “L” bracket is perpendicular to a longitudinal axis of the luminaire 100. The “L” bracket may allow the hinge 105 to rotate the light source carrying assembly 109 between the collapsed position and open position without allowing the light source carrying assembly 109 to rotate past an angle beyond perpendicular to a longitudinal axis of the luminaire 100.

Those skilled in the art will appreciate that the hinge 105 may be a torque or friction hinge in order to hold the light source carrying assembly 109 in place at any angle equal to or greater than the angle produced by the collapsed position. More specifically, the force needed to cause the hinge 105 to rotate may be greater than the force exerted by gravity on the light source carrying assembly that would result in a torque being applied to the hinge 105, such that gravity alone would not cause the hinge 105 to rotate. In such an embodiment, the hinge 105 allows a user to exert a greater force upon the hinge 105 than that which holds it at a current position in order to change the orientation of the light source carrying assembly 109. When a user removes the exerted force upon the light source carrying assembly 109, the threshold force required to rotate the hinge 105 would not be applied thereto and would hold the light source carrying assembly 109 in the reoriented position.

As perhaps best illustrated in FIG. 1, the power supply 103 of the collapsible luminaire 100 may be located within the housing lower section 102. The housing lower section 102 and the neck 104 may include a hollow interior capable of carrying the power supply 103 and the electrical circuitry necessary to operate the LEDs. The circuitry may extend from the power supply 103, through the neck 104 and into the circuit way cover 110 thereby providing covered electrical housing for the driving circuitry from the power supply 103 to the light source 106. Positioning the power supply 103 within the housing lower section 102 not only distances a heat generating element of the collapsible luminaire 100 from the light source 106, but also reduces the thickness of the light source carrying assembly 109 thereby enabling a more compact collapsed position for packaging.

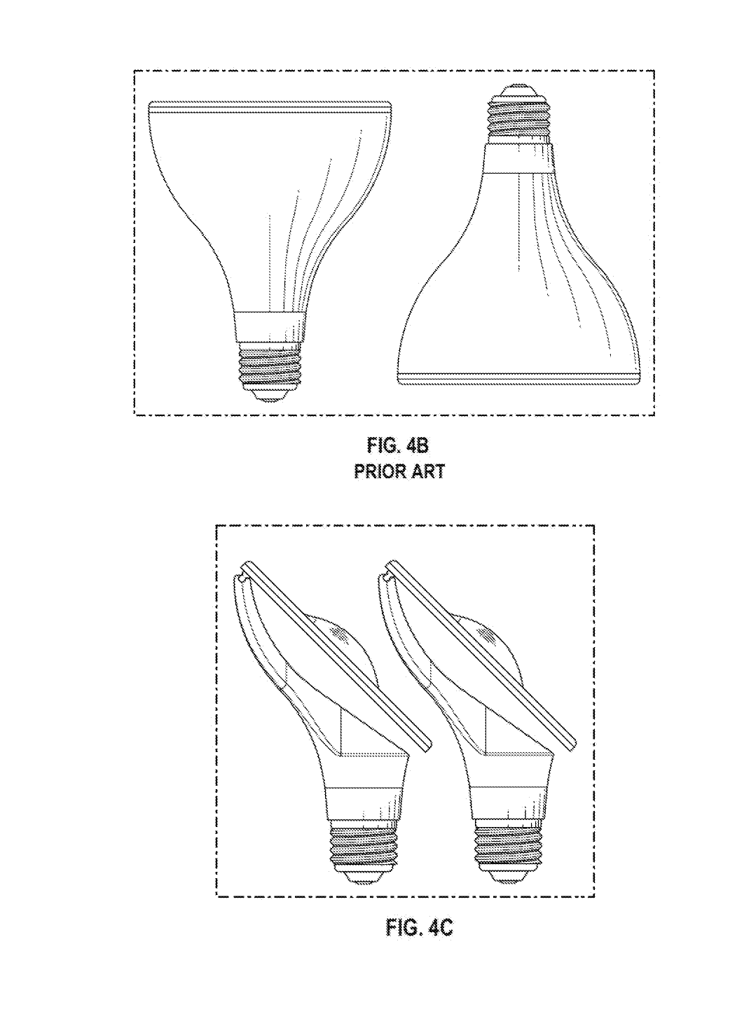

Referring now additionally to FIG. 4c, the collapsible nature of the collapsible luminaire 100 providing several advantages over traditionally structured lighting devices is shown. One such advantage is packaging. Packaging of traditional light bulbs involves orienting the bulbs in a manner that aligns them vertically parallel to each other, that is to say in the same vertical orientation. As discussed in the background above, and as illustrated in FIG. 4a, traditional packaging of luminaires involves the bases packaged at one end of the packaging and the optics at the other. This packaging method requires a larger box which, in turn, takes up a greater amount of shelf space in a retail outlet. The structure of traditional lighting has involved an Edison base and housing with a much narrower diameter than the optical chamber. In fact, the diameter of the optic may be more than five times larger than the base in traditional lighting. Therefore, packaging traditional lighting in a vertically parallel fashion minimizes space and material efficiency since the widest portion of the lighting devices are laid next to each other as demonstrated in FIG. 4a. To overcome this disadvantage, manufacturers have packaged the bulbs in an alternating inverse orientation so that the bases and optics of adjacent lighting devices are positioned at opposite ends of the packaging. As also discussed in the background, and as further demonstrated in FIG. 4b, this enables the space adjacent the smaller base of one bulb to be accommodated by the much larger diameter of the optical chamber of another bulb within the same packaging. Orienting the bulbs in the manner demonstrated in FIG. 4b may provide less than a 25% space efficiency over the traditionally packaged bulb shown in FIG. 4a. The structure of the lighting devices themselves do not allow for more efficient packaging.

The structure of the present invention may provide at least a 67% packaged space efficiency over the traditionally packaged bulb demonstrated in FIG. 4a. As shown, for example, in FIG. 4c, since the light source carrying assembly 109 is collapsible, the diameter of the portion of the lighting device opposite the base is greatly reduced when in the collapsed position. This enables the lighting devices to be efficiently positioned in a manner that aligns them vertically parallel to each other when packaged. When in the collapsed position, the light source carrying assembly 109 is abutting the arched neck housing 104. This orients the light source carrying assembly 109 at what may be approximately a 135-degree angle from the housing lower section 102 and may position it at a downward slant. Those skilled in the art will appreciate that the orientation of the light source carrying assembly 109 may also be within a range of between about 90 degrees to 150 degrees while still accomplishing the goals, features and objectives of the present invention. The downward slant of the light source carrying assembly 109 shown in FIG. 4c, as opposed to an orientation perpendicular to the base 101 shown in FIGS. 4a and 4b, allows for the space adjacent the downward slant to be accommodated by the neck 104 and collapsed light source carrying assembly 109 of another collapsible lighting device. As a result, more surface area of a plurality of collapsible lighting devices is able to symmetrically occupy a smaller packaging space than non-collapsible lighting.

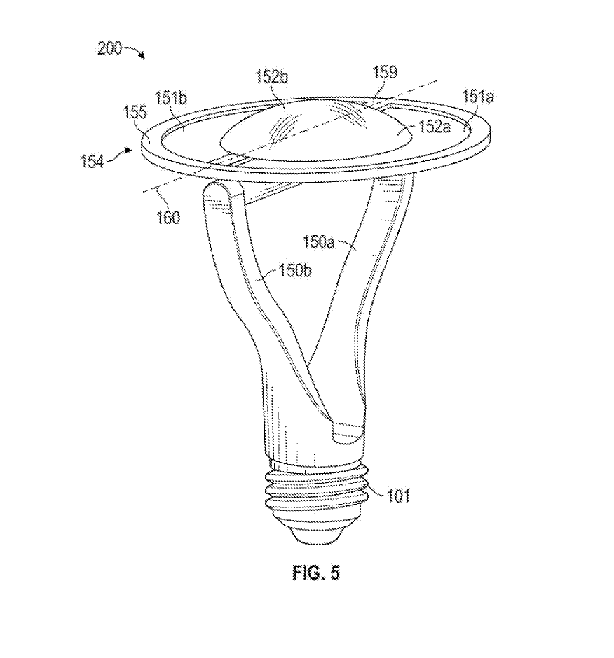

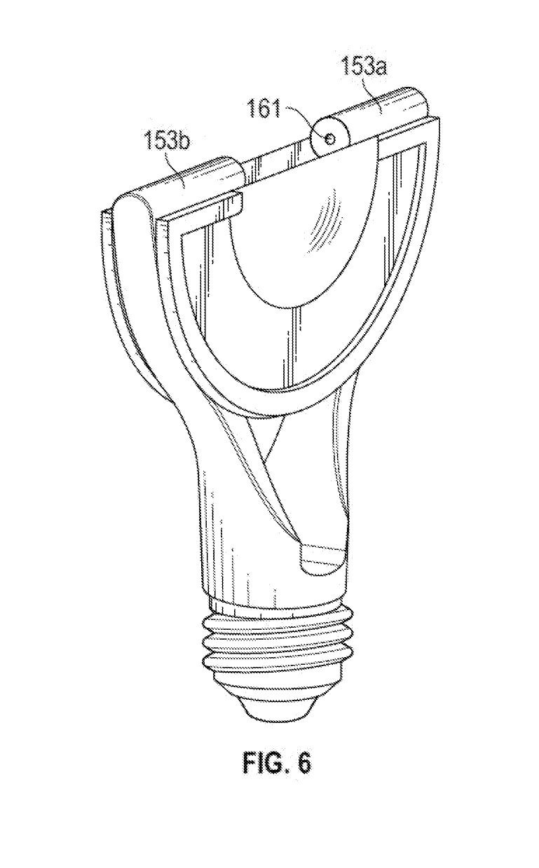

Referring now to FIGS. 5 and 6, a collapsible luminaire 200 according to another embodiment of the invention is presented. The collapsible luminaire 200 may include a base 101 connected to a first buttressed housing 150a and a second buttressed housing 150b. A distal end of each buttressed housing 150a, 150b may be connected to a first cylindrical hinge 153a and a second cylindrical hinge 153b respectively. Rotatably connected to the first and second cylindrical hinges 153a, 153b may be a bisected light source assembly 154. The bisected light source assembly 154 may be divided into two halves that comprise a first semicircular heat spreader 151a, a second semicircular heat spreader 151b, a first optic portion 152a, a second optic portion 152b and a bisected annular rim 155. The bisected light source assembly 154 may also include a light source (not shown) that includes a circuit board and LEDs or LED chip located thereon. The first and second optic portions 152a, 152b may be shaped as a semi-ellipsoid, semi-ovoid, semi-hemisphere, or any other shape capable of enclosing a light source and circuit board.

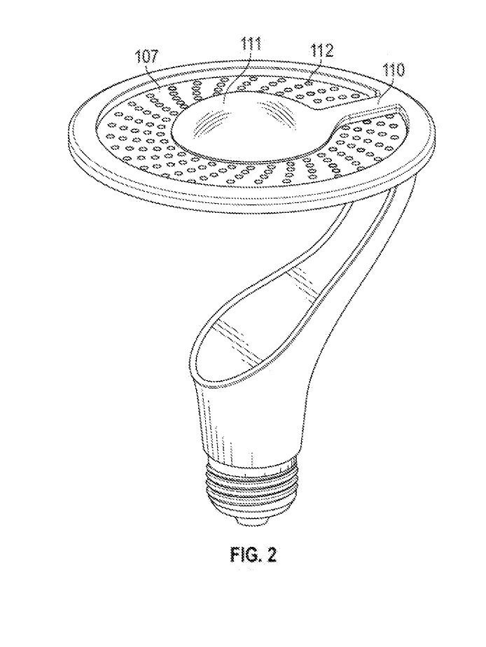

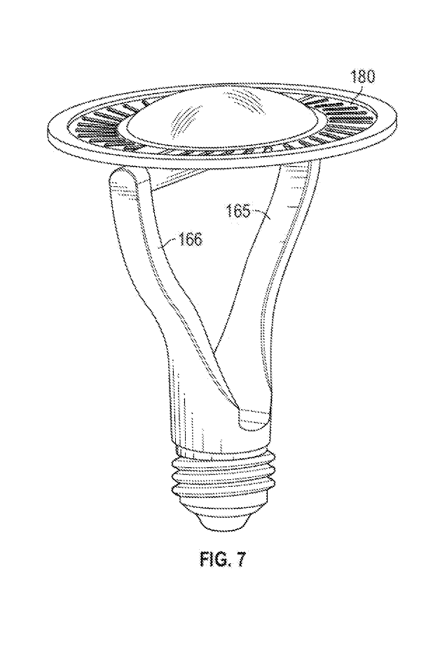

Referring additionally to FIG. 7, the first and second semicircular heat spreaders 151a, 151b may be made of any thermally conductive material capable of conducting heat away from the light source. By way of non-limiting example, the material may be metal, copper, or polycarbonate. The first and second semicircular heat spreaders 151a, 151b may circumscribe the light source or may serve as a platform on which the light source may fixedly be attached. The first and second semicircular heat spreaders 151a, 151b may be any thickness, which by way of non-limiting example may be between 0.125 and 2.0 inches. The first and second semicircular heat spreaders 151a, 151b may contain a plurality of thermally conductive fins 180 radially located around the first and second optic portions 152a, 152b. In some embodiments the plurality of thermally conductive fins 180 may be arcuate and may extend from the first and second optic portions 152a, 152b to the bisected annular rim 155. The thermally conductive fins 180 may conduct heat away from the light source toward the bisected annular rim 155 thereby enhancing the thermal dissipation capacity and the overall cooling capability of the bisected light source assembly 154. In other embodiments the first and second semicircular heat spreaders 151a, 151b may be solid planar surfaces as depicted in FIG. 5. Additionally, the solid planar surfaces of the first and second semicircular heat spreaders 151a, 151b may contain rows of thermal apertures 112 as in FIGS. 1 and 2 to enhance the thermal dissipation capacity and the overall cooling capability of the bisected light source assembly 154.

Each half of the bisected light source assembly 154 may rotate along a medial axis 160 provided by the first and second cylindrical hinges 153a, 153b. Although the cylindrical hinges 153a, 153b are cylinders in the current embodiment, they may be any jointed device or flexible piece on which the bisected light source assembly 154 turns, swings or moves. In the present embodiment the first and second cylindrical hinges 153a, 153b may serve as pivot points for the bisected light source assembly 154. As depicted in FIG. 6, the cylindrical hinges 153a, 153b may include a medial aperture 161 formed as a hollow interior channel. In some embodiments the medial aperture may serve as a covered means to deliver electrical circuitry from the first and second buttressed housing 150a, 150b to the light source.

Each buttressed housing 150a, 150b may include a width equal to the diameter of the base 101 at a proximal end before tapering at a distal end. Each buttressed housing 150a, 150b may include a pair of opposing wide surfaces defined as sides 165 and a pair of opposing thin surfaces defined as edges 166. Each buttressed housing 150a, 150b may be spaced apart at a nominal distance at the proximal end before extending outwardly in opposing arcuate structures to form a much wider distance apart towards the distal end. In some embodiments at least one of the buttressed housings 150a, 150b may include a hollow interior capable of carrying a power supply 103 and the electrical circuitry necessary to drive the LEDs or LED chip. However, it is contemplated to be within the scope herein that the power supply may be located between the base 101 and the proximal end of the buttressed housing 150a, 150b. It is also contemplated to be within the scope herein that the power supply may be located within a space defined by the first and second optic portions 152a, 152b located on the bisected light source assembly 154.

The bisected light source assembly 154 may be moveable between a collapsed and uncollapsed position. When in the collapsed position, each half of the bisected light source assembly 154 may abut, and align parallel to opposing buttressed housing edges 166 as shown in FIG. 6. When in the uncollapsed position, each half of the bisected light source assembly 154 may be connected along a medial bisection point and formed as a monolithic unit perpendicular to the buttressed housing edges 166 as shown in FIGS. 5 and 7. The cylindrical hinges 153a, 153b may allow each half of the bisected light source assembly 154 to rotate between the collapsed and uncollapsed position. In some embodiments the hinges 153a, 153b may include a fastening bracket configured to hold each half of the bisected light source assembly 154 together. In other embodiments the bisected light source assembly 154 may be frictionally engaged with its axis 160 so as to hold each half into a user defined position. In still other embodiments the bisected light source assembly 154 may contain raised fitting members 159 configured to engage a friction fit with one another. In other embodiments the raised fitting members 159 may be configured to interlock when in the uncollapsed position.

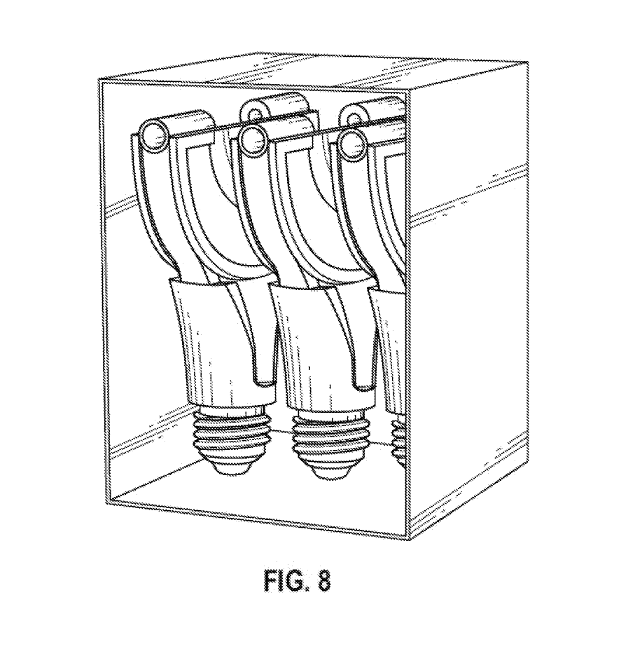

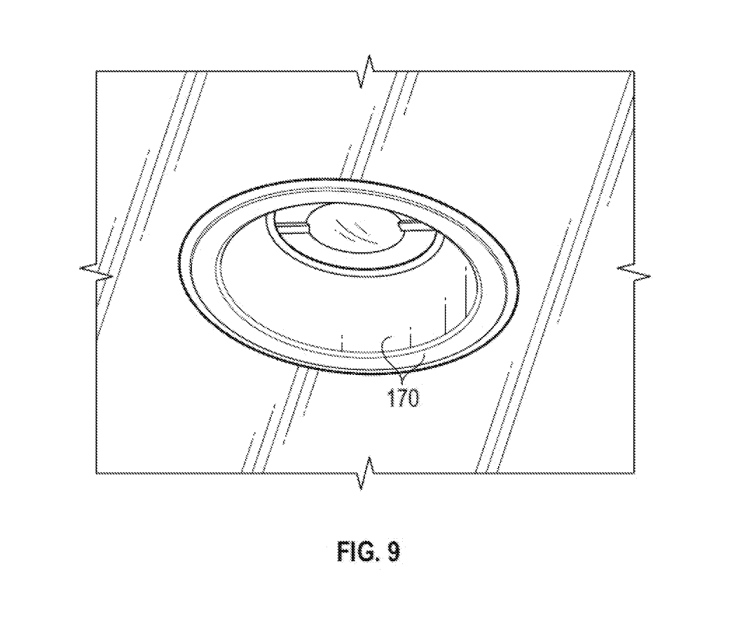

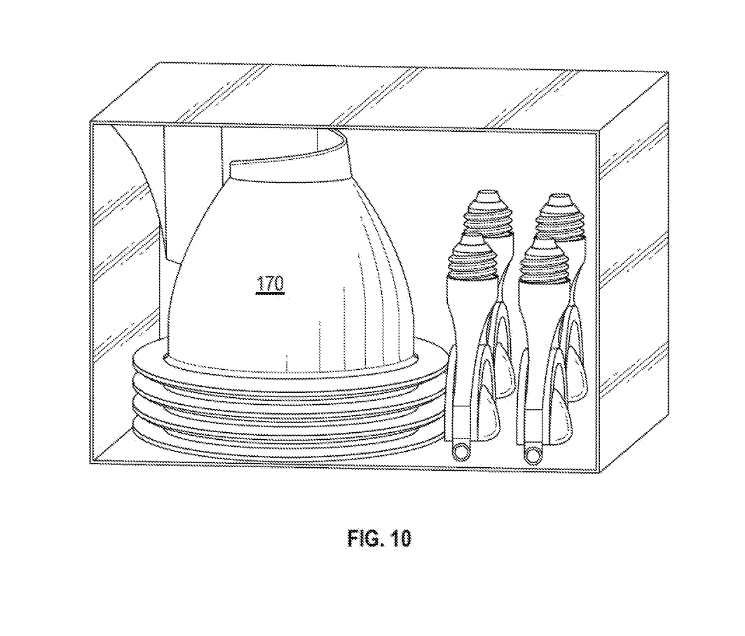

As noted above and as shown in FIGS. 8-10, the configuration of the collapsible luminaire 200 in the collapsed position provides marked improvement over traditional packaging. FIG. 8 demonstrates three collapsed luminaires 200 in the collapsed position occupying a space that would normally occupy a single traditional non-collapsible lighting device. Likewise, when the collapsible luminaire 200 is used as a part of a kit in conjunction with a reflector assembly 170 as shown in FIG. 9, the packaging advantages are demonstrated in FIG. 10.

FIG. 10 shows a disassembled luminaire kit whereby a plurality of lighting devices may easily occupy a small packaging container when multiple reflector assemblies 170 are stacked upon one another and multiple collapsible luminaires are collapsed and fitted adjacent thereto. Therefore, a manufacturer is able to package several lighting devices in a package dimensioned to fit a single traditional lighting device.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

That which is claimed is:

1. A collapsible luminaire comprising:
a light source carrying assembly;
a housing lower section;
at least one neck; and
at least one hinge.

2. The collapsible luminaire according to claim 1 wherein the housing lower section comprises a power supply.

3. The collapsible luminaire according to claim 1 wherein the at least one neck is an arched member extending from the housing lower section to the light source carrying assembly.

4. The collapsible luminaire according to claim 1 wherein the lightsource carrying assembly is disk shaped and comprises a heat spreader with two opposing planar surfaces.

5. The collapsible luminaire according to claim 4 wherein the heat spreader comprises a plurality of thermal apertures.

6. The collapsible luminaire according to claim 4 wherein the heat spreader is a thickness within a range from 0.125 inches to 2 inches.

7. The collapsible luminaire according to claim 1 wherein the at least one hinge is configured as a pivot point for the light source carrying assembly; and wherein the light source carrying assembly is configured to be moveable between one of collapsed and un-collapsed when the light source carrying assembly has rotated about the at least one hinge.

8. The collapsible luminaire according to claim 1 wherein the light source carrying assembly is configured to be collapsed when the light source carrying assembly abuts the at least one neck.

9. A collapsible luminaire comprising:
a light source carrying assembly comprising a heat spreader, a light source, an optic and an annular rim;
an arched neck;
a hinge; and
a housing lower section comprising a power supply;
wherein the hinge is connected to the arched neck and the light source carrying assembly; and
wherein the hinge is configured as a pivot point for the light source carrying assembly.

10. The collapsible luminaire according to claim 9 wherein the light source carrying assembly is disk shaped.

11. The collapsible luminaire according to claim 9 wherein the heat spreader comprises a plurality of arcuate rows of thermal apertures extending from the optic to the annular rim.

12. The collapsible luminaire according to claim 9 wherein the light source carrying assembly further comprises a circuit way cover extending from the annular rim to the optic.

13. The collapsible luminaire according to claim 12 wherein the housing lower section, the arched neck, and the circuit way cover are configured as electrical housings for driving circuitry extending from the power supply to the light source.

14. The collapsible luminaire according to claim 9 further comprising a base; wherein the housing lower section is attached to the base; and wherein the base is one of an Edison base, a bi-pin, and a wedge.

15. A collapsible luminaire comprising:
a base;
a first buttressed housing and a second buttressed housing;
at least one hinge; and
a bisected light source assembly;
wherein each half of the bisected light source assembly is configured to rotate along a medial axis defined by the at least one hinge.

16. The collapsible luminaire according to claim 15 wherein the bisected light source assembly comprises:
a first section comprising:
a first semicircular heat spreader,
a first optic portion, and
a first bisected annular rim portion; and
a second section comprising:
a second semicircular heat spreader,
a second optic portion, and
a second bisected annular rim portion;
wherein the bisected light source assembly is configured to be foldable.

17. The collapsible luminaire according to claim 16 wherein the first semicircular heat spreader and second semicircular heat spreader includes a plurality of thermally conductive fins radially located around the first and second optic portions.

18. The collapsible luminaire according to claim 16 wherein the first optic portion and the second optic portion are both one of semi-ellipsoid, semi-ovoid, and semi-hemisphere in shape.

19. The collapsible luminaire according to claim 15 wherein at least one of the first and second buttressed housings includes a hollow interior capable of carrying a power supply and electrical circuitry configured to drive LEDs located on the bisected light source assembly.

20. The collapsible luminaire according to claim 15 wherein the at least one hinge comprises a plurality of cylindrical hinges, each cylindrical hinge comprising a medial aperture formed as a hollow interior channel configured to facilitate connection of electrical circuitry from at least one of the first buttressed housing and the second buttressed housing to a light source.
